(19) United States
(12) Patent Application Publication
(10) Pub. No.: US 2002/0126577 A1
(43) Pub. Date: Sep. 12, 2002

(54) Multibeam synthetic aperture sonar

(75) Inventor: Steven R. Borchardt, Vienna, VA (US)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Dynamics Technology, Inc.

(21) Appl. No.: 10/053,649

(22) Filed: Jan. 24, 2002

Related U.S. Application Data
(60) Provisional application No. 60/263,758, filed on Jan. 25, 2001.

(51) Int. Cl. G01S 15/89

(52) U.S. Cl. 367/88

(57) ABSTRACT

A multibeam synthetic aperture sonar system that includes a sonar projector. The projector transmits a transmitted sonar signal. A multibeam sonar receiver receives a reflected sonar signal created by the reflection of the transmitted sonar signal off materials and objects ensonified by the transmitted sonar signal. The receiver generates an output signal representative of the reflected sonar signal. The synthetic aperture sonar processor receives the signal output from the multibeam sonar receiver and processes the signal with synthetic aperture algorithms.

This application claims the benefit of U.S. Provisional Application No. 60/263,758, filed Jan. 25, 2001. This application is hereby incorporated by reference.

### BACKGROUND OF THE INVENTION

1. Field of the Invention

This invention relates generally to sonar systems and more particularly to synthetic aperture sonar systems.

2. Description of the Related Art

A sonar system may be used to detect, navigate, track, classify and locate objects in water using sound waves. Military and non-military applications of sonar systems are numerous.

In military applications, underwater sound is used for depth sounding; navigation; ship and submarine detection, ranging, and tracking (passively and actively); underwater communications; mine hunting; and/or guidance and control of torpedoes and other weapons.

Non-military applications of underwater sound detection systems are numerous as well. These applications are continuing to increase as attention is focused on the hydrosphere, the ocean bottom, and the sub-bottom. Non-military applications include depth sounding; bottom topographic mapping; object location; underwater beacons (pingers); wave-height measurement; Doppler navigation; fish finding; sub-bottom profiling; underwater imaging for inspection purposes; buried-pipeline location; underwater telemetry and control; diver communications; ship handling and docking aid; anti-stranding alert for ships; current flow measurement; and vessel velocity measurement.

A typical active sonar system includes a transmitter (a transducer commonly referred to as a “source” or “projector”) that generates sound waves (commonly referred to as a ping or pings) and a receiver (a transducer commonly referred to as a “hydrophone”) that senses and measures the properties of the reflected energy (also referred to as an echo) including, for example, amplitude and phase.

Conventional Multibeam Sonar (MBS)

FIG. 1 illustrates a conventional MBS system installed on the hull 10 of a ship. Spatial resolution in conventional MBS systems is achieved using narrow beamwidths. High resolution requires physically large arrays. In traditional Mills Cross MBS systems this is achieved by using a long linear projector 14 aligned along the ship track and a long linear receiver array 12 aligned cross-track. The sonar beam patterns produced in a typical Mills Cross MBS system are shown in FIG. 2. The projector produces a fan beam 22 that is narrow along-track and wide cross-track, while the receiver array forms multiple fan beams 24 that are wide along-track and narrow cross-track. The resulting two-way beam patterns 26 are therefore narrow in both directions.

Thus, in a typical multibeam sonar system, a first transducer array 14 (“transmitter or projector array”) is mounted along the keel of a ship and radiates sound. A second transducer array 12 (“receiver or hydrophone array”) is mounted perpendicular to the transmitter array. The receiver array 12 receives the “echoes” of the transmitted sound pulse, i.e., returns of the sound waves generated by the transmitter array 14.

In those instances where the transmitter array is mounted along the keel of the ship, the transmitter array projects a fan-shaped sound beam 22 which is narrow in the fore and aft direction but wide athwartships. The signals received by the hydrophones in the receiver array are summed to form a receive beam 24 which is narrow in the across track but wide in the along track direction. The intersection of the transmit and receive beams define the region 26 in the sea floor from where the echo originated. By applying different time delays to the different hydrophone signals the receive beams can be steered in different directions. When a number of receive beams 24 are formed simultaneously they together with the transmit beam 22 define the multibeam sonar geometry.

For a given frequency, the narrow width of the receive beam is governed by the number of hydrophones comprising the receiver array (i.e., the physical length of the receiver array) and the direction to which the beam is steered. A common rule of thumb for determining the receive beam width (bw)(in degrees) is shown in equation (1):

$$bw = \frac{51 λ}{a cos θ} \qquad ( 1 )$$

where:

a is the length of the array;

λ is the wavelength (determined by the frequency of the sound wave of the projector) in the same units as “a” (the length of the array); and

θ is the angle of the beam steer measured from nadir in radians.

Thus, it can be seen that for narrower beam widths the length of the receiver array should be larger. A “narrower” beam width of the receiver beam increases the information that may be obtained about the reflecting objects, e.g., object resolution and accuracy of object direction. However, in many applications of multibeam sonars, the physical characteristics of the receiver array are constrained by the physical characteristics of the ship. For example, in many instances where the receiver arrays are mounted athwartships for multibeam sonars, the maximum physical length of the array is restricted by the width of the ship. Additionally, narrower beamwidth arrays are more expensive than wider beamwidth arrays.

Conventional Synthetic Aperture Sonar (SAS)

A typical SAS array 30 installed on the hull 10 of a ship is shown in FIG. 3. A close up view of array 30 is shown in FIG. 4. In contrast to MBS, conventional SAS achieves high spatial resolution by using a relatively short projector 32 which may also be used as a receive element and short receive elements 34, each having relatively wide along-track beamwidths 40, 42, 44 so that beam patterns on the ground at normal operating ranges nearly coincide as shown in FIG. 5. The wide beamwidths insure that targets are ensonified by multiple sonar pings as the vehicle advances, and successive pings are coherently integrated by the SAS processor to improve along-track resolution. The beamwidths of the projector and receive elements are typically matched to maximize two-way directivity.

The individual short receive elements 34 are typically deployed in a long linear array 30 aligned along the ship track. This permits higher speed of advance with ping rates (sonar pulse repetition frequency) that satisfy the standard synthetic aperture range-Doppler ambiguity requirements. When only a single receive element 34 is used the ship could advance no more than half an element length L₁ between pings. If it moved further, the phase history of the scene would no longer be Nyquist sampled, and it would no longer be possible to reconstruct the scene unambiguously.

When using a linear array 30 of N receive elements, the ship can move up to half of the length of the full array L₂ (N times the single element length L₁) between pings while still Nyquist sampling the scene phase history. This permits ship speeds that are N times larger than would be allowed with a single element.

Thus, where conventional MBS uses a relatively long projector array and a relatively short (in the along-track direction) receive array, conventional SAS uses a relatively short projector and a relatively long receive array. Thus, multibeam sonars are generally considered to be incompatible with synthetic aperture processing.

### SUMMARY OF THE INVENTION

A multibeam synthetic aperture sonar system including a sonar projector and multibeam receiver array. The projector transmits a transmitted sonar signal. A multibeam sonar receiver array receives reflected sonar signals created by the reflection of the transmitted sonar signal off materials and/or objects ensonified by the transmitted sonar signal. The receiver array generates an output signal representative of the reflected sonar signal. A synthetic aperture sonar processor receives the signal outputs from the multibeam sonar receiver array and processes the signal from each beam with synthetic aperture algorithms.

An improved multibeam sonar system is disclosed, where the improvement includes a synthetic aperture sonar processor. The processor receives a signal output from a multibeam sonar receiver. The signal output represents the sonar signal received by the multibeam sonar receiver. The processor processes the signal output from the multibeam sonar receiver using synthetic aperture algorithms.

A multibeam synthetic aperture sonar is disclosed that includes a transmitting means for transmitting a sonar ping. A multibeam receiving means receives a multibeam sonar echo and generates an output signal representative of the received echo. A synthetic aperture sonar processing means processes the output signal from the multibeam receiving means and processes sonar ping data from the transmitting means using synthetic aperture sonar algorithms.

A method of processing a multibeam sonar signal is disclosed. The method includes receiving a signal from a multibeam sonar receiver array. Transmit data is received from a multibeam sonar projector. The received signal and the received data are processed using synthetic aperture algorithms.

### BRIEF DESCRIPTION OF THE SEVERAL VIEWS OF THE DRAWINGS

The accompanying drawings incorporated in and forming part of the specification illustrate several aspects of the present invention, and together with the description serve to explain the principles of the invention. In the drawings:

FIG. 1 illustrates a conventional Mills Cross multibeam sonar installed on the hull of a ship.

FIG. 2 illustrates the beam patterns formed by the transmit and receive transducers of a Mills Cross multibeam sonar system.

FIG. 3 illustrates a conventional synthetic aperture sonar array installed on the hull of a ship.

FIG. 4 illustrates an enlarged view of the synthetic aperture array illustrated in FIG. 3.

FIG. 5 illustrates the beam patterns formed by the synthetic aperture sonar array illustrated in FIGS. 3 and 4.

FIG. 6 shows the maximum depth/speed regime for a multibeam SAS using the same conventional MBS transmit transducer and receiver arrays.

FIG. 7 compares the along track resolution of a conventional MBS with a 2° angular resolution to the along track resolution of a multibeam SAS using the same conventional MBS transmit transducer and receiver arrays.

FIG. 8 compares the along track resolution of a conventional MBS with a 1° angular resolution to the along track resolution of a multibeam SAS using the same conventional MBS transmit transducer and receiver arrays.

FIG. 9 illustrates an exemplar block diagram of the invention.

FIG. 10 illustrates a second embodiment of the invention shown in FIG. 9 that includes interferometric processing.

Reference will now be made in detail to the invention, examples of which are illustrated in the accompanying drawings.

### DETAILED DESCRIPTION OF THE INVENTION

Overview

The multibeam synthetic sonar system employs existing or modified synthetic aperture sonar signal processing algorithms to process the sonar signal output from conventional Mills Cross or other multibeam sonar systems. This system, when operated within specified speed/depth regimes, provides improved along-track resolution even though conventional MBS receive arrays are too short in the along-track direction by traditional SAS standards.

In a multibeam SAS using the projector and receive arrays of a conventional (i.e., Mills Cross) MBS system, the beamwidth at the scene is determined by the beamwidth of the relatively long projector array not by the relatively short receive array. Therefore, when operating in the regime of water depths and vehicle speeds for which synthetic aperture range-Doppler ambiguities can be avoided, this system transmits multiple pings which are coherent ping-to-ping and coherently integrates the data in each receive beam to improve along-track resolution.

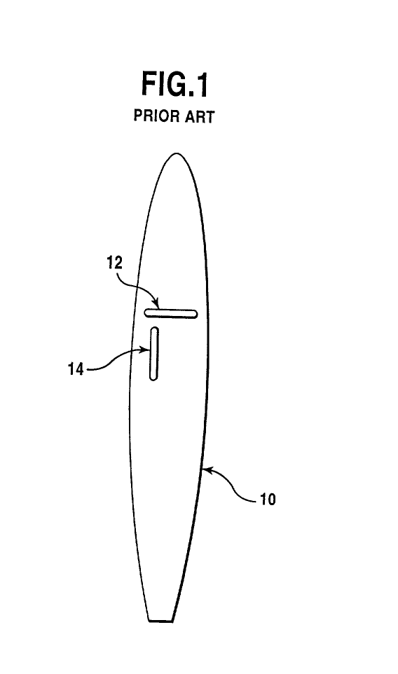

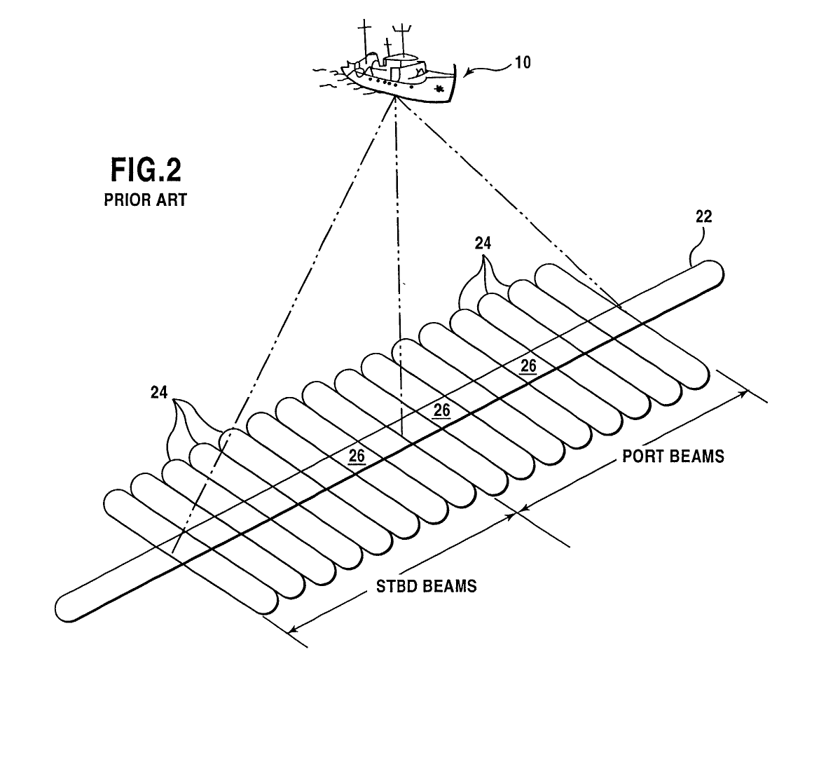

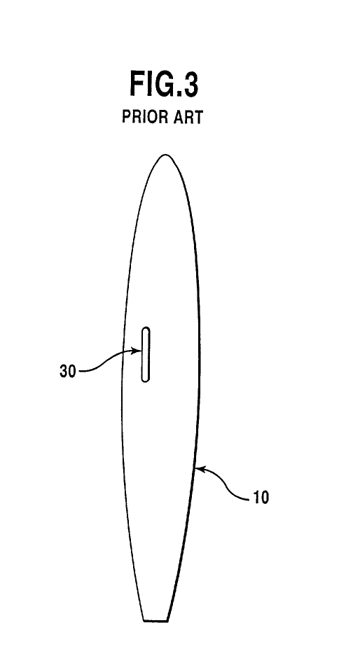

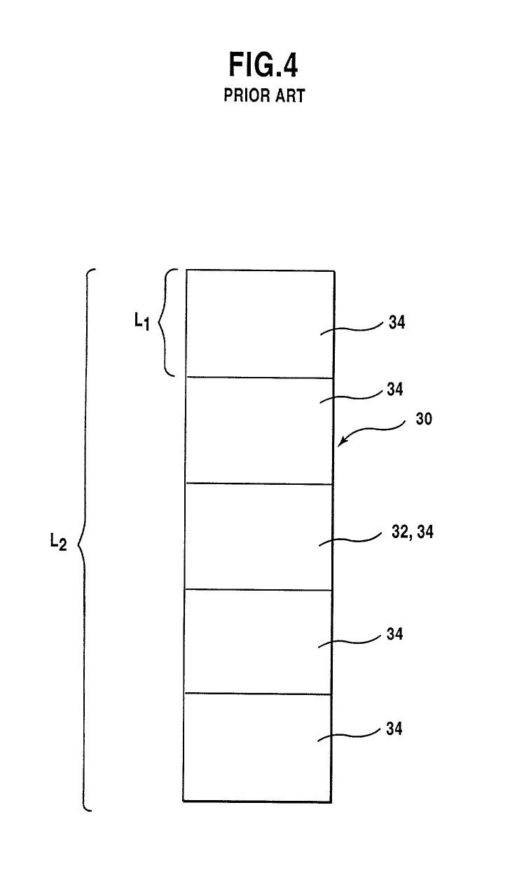

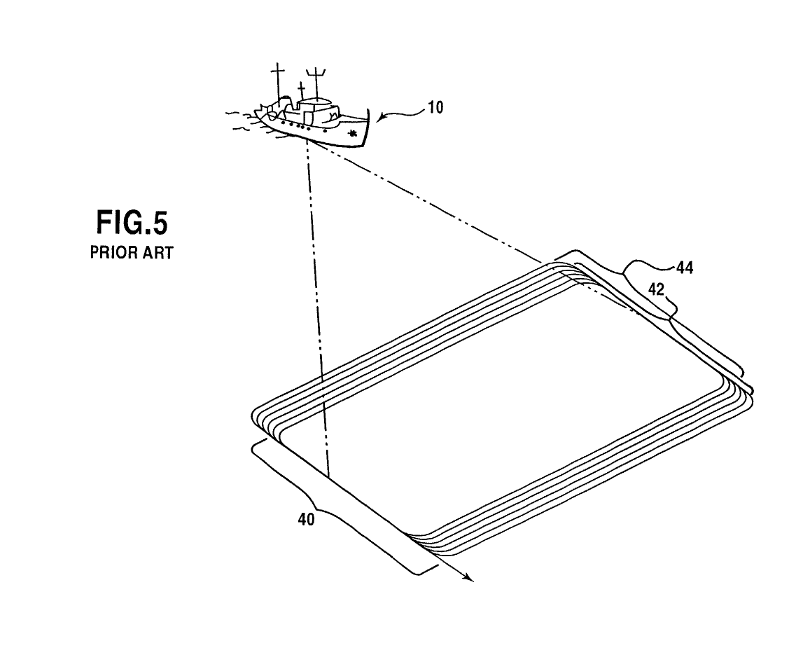

For a multibeam SAS using transducer arrays from a conventional MBS Mills Cross configuration shown in FIG. 1 the condition that the sonar data be unambiguously sampled in range and Doppler is given by equation (2):

$$\frac{2 V}{L} \leq PRF \leq \frac{c}{2 H} cos ( {θ}_{max} ) \qquad ( 2 )$$

where:

c is the speed of sound in water;

PRF is the pulse repetition frequency;

V is the vehicle speed;

L is the along-track length of the projector array;

H is the water depth; and

θₘₐₓ is the nadir angle of the outermost receive beam.

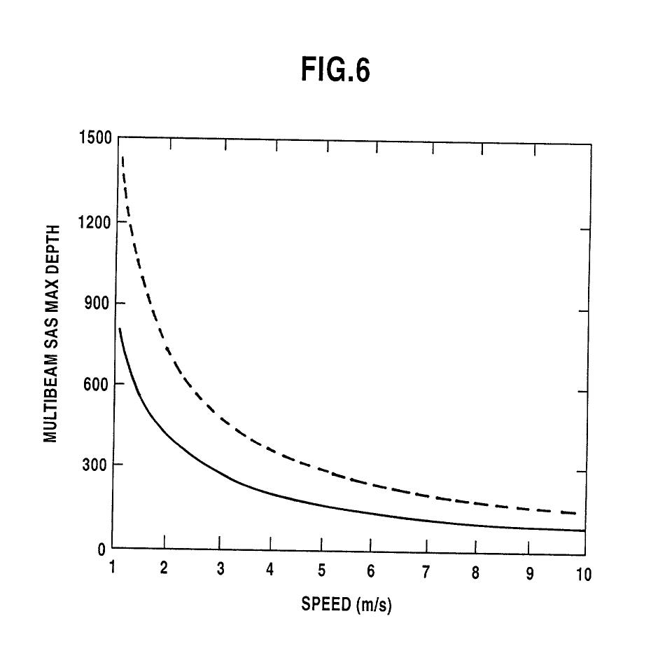

For existing MBS transducer arrays, there is a wide speed/depth regime over which these conditions can be met. The dotted line in FIG. 6 illustrates an exemplar maximum speed/depth regime for a multibeam SAS using a projector array having a 1° beamwidth. The solid line in FIG. 6 illustrates an exemplar maximum speed/depth regime for a multibeam SAS using a projector array having a 2° beamwidth. Within each regime shown in FIG. 6, the theoretical along-track resolution achievable with coherent processing is half the length of the projector 14. This is to be compared with the along-track resolution for conventional MBS processing given by equation (3):

R=Hδθ sec(θₘₐₓ) (3)

where:

R is the along-track resolution;

δθ is the along-track beamwidth of the projector array (typically 1° to 2°);

H is the water depth; and

θₘₐₓ is the nadir angle of the outermost receive beam.

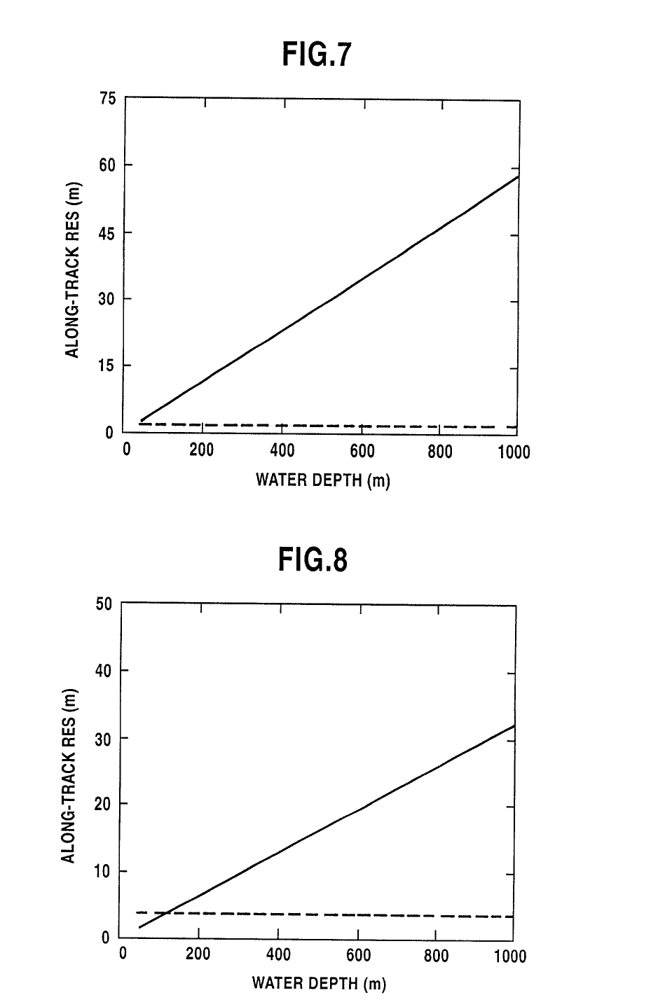

Over most of the allowed speed/depth regime, the multibeam SAS resolution will be substantially better than conventional MBS resolution. FIGS. 7 and 8 provide a comparison between conventional 2°×2° and 1°×1° MBS systems respectively and multibeam SAS systems using the same transmitter transducer and receiver arrays. The solid lines illustrate the resolution of the convention MBS systems and the dotted lines illustrate the resolution of the multibeam SAS systems.

A multibeam SAS utilizing the long cross-track receive array with its individually addressable elements can support multiple baseline interferometric processing. By combining interferometry and SAS processing a multibeam SAS improves not only the horizontal spatial resolution, but also the vertical resolution. Therefore, the combination of multiple baseline interferometry and SAS should also support other hydrographic applications such as improved precision three dimensional bathymetric mapping and three dimensional coherent change detection, which are routinely exploited in synthetic aperture radar.

A multibeam SAS utilizing multiple pings in the water can increase the area coverage rate (ACR) over a single ping and receive SAS. To use multiple pings, a ping interval or pulse repetition rate is selected that does not incur range ambiguity. Range ambiguity is dictated by the spread in range, rather than the maximum range. When using multiple pings, the ACR and the SAS speed constraint can be improved over that indicated in FIG. 6 and Equation 2 by using a higher PRF. A higher PRF allows the ship to travel faster. Thus, the ship's speed and the maximum PRF may be adjusted to maximize ACR. The use of multiple pings in conventional synthetic aperture technology is well known.

Multibeam SAS

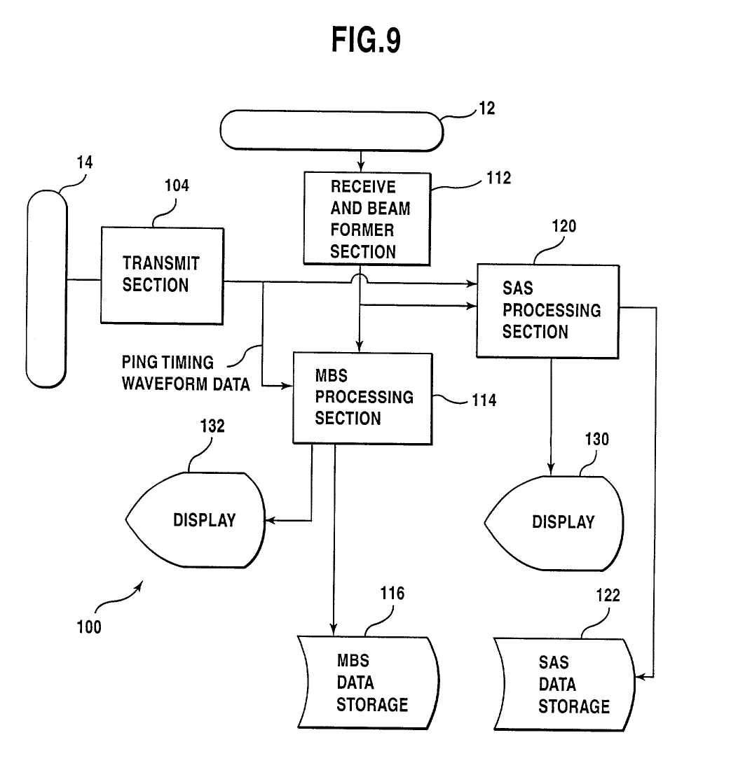

FIG. 9 illustrates a block diagram of a multibeam SAS 100 that uses a projector array 14 and a multibeam receiver array 12. A transmit section 104 controls the sonar output of the projector array 14 and provides transmit signal data to the MBS processing section 114 and SAS processor section 120. A receive section 112 controls the receiver array 12 and contains a beamformer. This section typically amplifies and pre-processes the signals received from the receiver array 12 into multiple cross track beams. The SAS section 120 receives the signal output from the receive section 112 and transmit signal timing and/or waveform data from the transmit section 104. The SAS section 120 processes these signals and/or data using synthetic aperture algorithms. These algorithms may be conventional synthetic aperture algorithms known in the art or modifications thereto.

In some embodiments the receive section 112 may be integrated into the SAS processing section 120. Thus, a multibeam receiver may have just a multibeam receiver array 12 or may also include the receive section 112. The processed data may be stored in SAS data storage 122 and/or displayed on display 130. In the currently preferred embodiment the data is both stored and displayed.

In some embodiments it may be desired and/or useful to include an MBS processing section 114 that is known in the art. In embodiments where the SAS processor 120 is added to “upgrade” an existing conventional MBS, the MBS section 114 may remain installed or may be removed. In systems including an MBS processing section, there may also be an output to display 132 and MBS data storage 116. In some embodiments the SAS processor 120 and MBS processor 114 may share the display and data storage. In other embodiments the SAS processor 120 and the MBS processor 114 may be combined in a single unit.

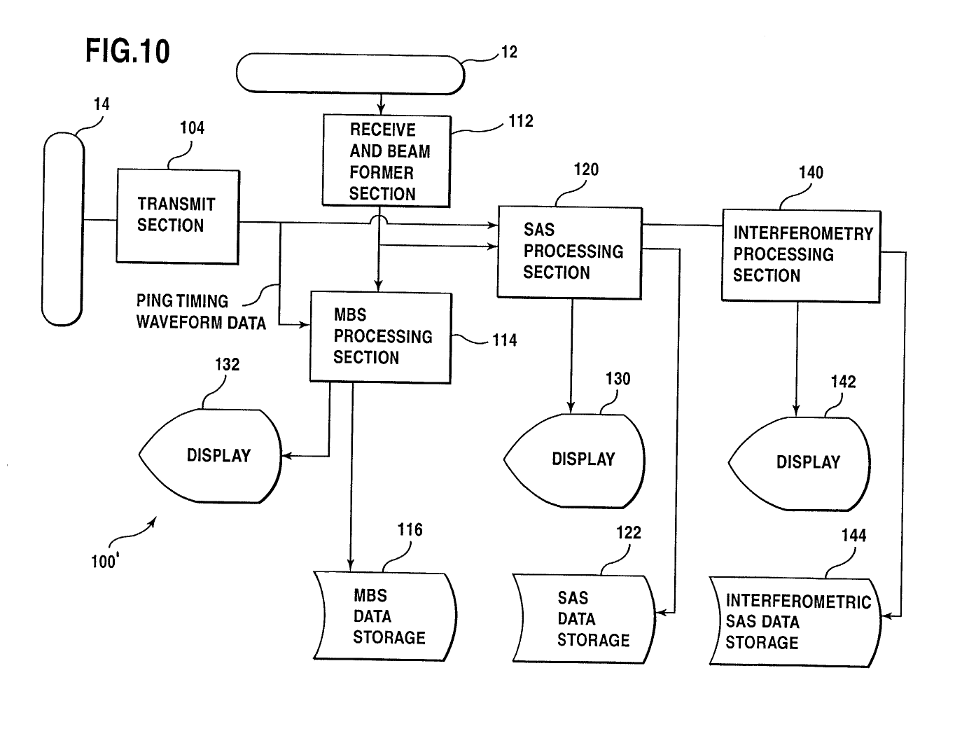

FIG. 10 illustrates a block diagram of a multibeam SAS 100′ that includes interferometric processing for improved vertical resolution. The improved resolution of this system should support hydrographic applications such as improved precision three dimensional bathymetric mapping and three dimensional coherent change detection. To support the interferometric processing, an output from the SAS processing section 120 is provided to interferometry processing section 140. Interferometry processing section 140 processes the signal and/or data from the SAS processing section 120 using interferometric algorithms. These algorithms may be conventional interferometric algorithms known in the synthetic aperture art or modifications thereto. The output from interferometry section 140 may be displayed on a display 142 and/or stored in an interferometric SAS data storage 144.

In some embodiments, the SAS processing section 120 and the interferometry processing section 140 may share a display and/or data storage. Similarly, in other embodiments, the MBS processing section 114, the SAS processing section 120 and the interferometry processing section 140 may share a display and/or data storage.

MBS processing section 114, the SAS processing section 120 and the interferometry processing section 140 may be implemented in hardware or software.

Multibeam SAS Example

For a configuration using a typical 12 kHz multibeam system, FIG. 6 displays the speed/depth regime over which the SAS range-Doppler ambiguity can be met for a 120° swath. The dotted curve corresponds to the performance envelope of a typical 1°×1° system and the solid curve to a typical 2°×2° system.

For a given projector length, there is a trade-off between ship speed and maximum depth for SAS processing. Greater depths could also be achieved at any given speed by reducing the swath coverage to permit greater along-track resolution. For example, narrowing the swath from 120° to 90° would increase the maximum allowable water depths shown in FIG. 6 by 50%

It is also worth noting that the resolution gains increase with increasing depth. FIGS. 7 and 8 compare the along-track resolution achievable with a typical conventional multibeam system and that achievable with a multibeam SAS using the same projector and receiver array. FIG. 7 corresponds to the 2°×2° system and FIG. 8 to the 1°×1° system at the edge of the 120° swath. The solid curves are for the conventional MBS system and dotted curves for the multibeam SAS system. For both figures, the maximum water depths for SAS processing are constrained to the speed/depth regimes discussed above. When the multibeam SAS is operated with multiple pings in the water, then higher speeds and/or greater depths may be achieved. The operation and trade offs associated with multiple ping operations are well known in conventional SAS and are applicable to multibeam SAS.

In summary, numerous benefits have been described that result from applying the concepts of the invention. The description of the invention has been prepared for the purposes of illustration and description. It is not intended to be exhaustive or to limit the invention to the precise form disclosed. Obvious modifications and variations are possible in light of the above teaching. The present embodiment was chosen and described in order to best illustrate the principles of the invention and its practical application to enable one of ordinary skill to utilize the invention in various embodiments and with various modifications as suited to the particular use contemplated. It is intended that the scope of invention be defined by the claims appended hereto.

What is claimed is:

1. A multibeam synthetic aperture sonar system comprising:
a sonar projector, the projector transmits a transmitted sonar signal;
a multibeam sonar receiver, the receiver receives a reflected sonar signal created by the reflection of the transmitted sonar signal off materials and objects ensonified by the transmitted sonar signal, the receiver generates an output signal representative of the reflected sonar signal; and
a synthetic aperture sonar processor, the processor receives the signal output from the multibeam sonar receiver, the processor also receives transmit signal data from the projector, and the processor processes the received signal and received data using synthetic aperture algorithms.

2. The sonar system of claim 1, further comprising:
a display, the display receives and displays an output from the synthetic aperture sonar processor.

3. The sonar system of claim 1, further comprising:
a data storage, the data storage receives and stores an output from the synthetic aperture sonar processor.

4. The sonar system of claim 3, further comprising:
a display, the display receives and displays an output from the synthetic aperture sonar processor.

5. The sonar system of claim 1, further comprising:
an interferometry processor, the interferometry processor receives and processes an output from the synthetic aperture sonar processor using interferometric algorithms.

6. The sonar system of claim 5, further comprising:
a display, the display receives and displays an output from the synthetic aperture sonar processor.

7. The sonar system of claim 5, further comprising:
a data storage, the data storage receives and stores an output from the synthetic aperture sonar processor.

8. The sonar system of claim 7, further comprising:
a display, the display receives and displays an output from the synthetic aperture sonar processor.

9. The sonar claim of 1, wherein:
the sonar operates with multiple pings in the water.

10. An improved multibeam sonar system, wherein the improvement comprises:
a synthetic aperture sonar processor, the processor receiving a signal output from a multibeam sonar receiver, the signal output being representative of the sonar signal received by the multibeam sonar receiver, the processor processing the signal output from a multibeam sonar receiver using synthetic aperture algorithms.

11. The improved sonar system of claim 10, further comprising:
an interferometry processor, the interferometry processor receives and processes an output from the synthetic aperture sonar processor using interferometric algorithms

12. A multibeam synthetic aperture sonar comprising:
transmitting means for transmitting a sonar ping;
multibeam receiving means for receiving a multibeam sonar echo and generating an output signal representative of the received echo; and
synthetic aperture sonar processing means for processing the output signal from the multibeam receiving means and for processing sonar ping data from the transmitting means using synthetic aperture sonar algorithms.

13. The sonar system of claim 12, further comprising:
a interferometry processing means for processing an output from the synthetic aperture sonar processing means using interferometric algorithms.

14. The sonar system of claim 13, further comprising:
a display, the display receives and displays an output from the synthetic aperture sonar processor.

15. The sonar system of claim 13, further comprising:
a data storage, the data storage receives and stores an output from the synthetic aperture sonar processor.

16. The sonar system of claim 15, further comprising:
a display, the display receives and displays an output from the synthetic aperture sonar processor.

17. The sonar system of claim 12, further comprising:
a display, the display receives and displays an output from the synthetic aperture sonar processor.

18. The sonar system of claim 12, further comprising:
a data storage, the data storage receives and stores an output from the synthetic aperture sonar processor.

19. The sonar system of claim 18, further comprising:
a display, the display receives and displays an output from the synthetic aperture sonar processor.

20. A method of processing a multibeam sonar signal, the method comprising:
receiving a signal from a multibeam sonar receiver array;
receiving transmit data from a sonar projector; and
processing the received signal and the received data using synthetic aperture sonar algorithms.

21. The method of claim 20, further comprising:
processing an output of the synthetic aperture sonar algorithms using interferometric algorithms.

22. The method of claim 21, further comprising:
displaying an output of the interferometric algorithms.

23. The method of claim 21, further comprising:
storing an output of the interferometric algorithms.

24. The method of claim 23, further comprising:
displaying an output of the interferometric algorithms.

25. The method of claim 20, further comprising:
displaying an output of the interferometric algorithms.

26. The method of claim 20, further comprising:
storing an output of the interferometric algorithms.

27. The method of claim 26, further comprising:
displaying an output of the interferometric algorithms.
